(19) United States
(12) Patent Application Publication
(10) Pub. No.: US 2025/0174721 A1
(43) Pub. Date: May 29, 2025

(54) NONAQUEOUS ELECTROLYTE AND BATTERIES CONTAINING THE SAME

(71) Applicant: Eagle Picher Technologies, LLC, Joplin, MO (US)

(72) Inventors: Thomas J. BARBARICH, Joplin, MO (US); Frank PUGLIA, Joplin, MO (US); Boris RAVDEL, Joplin, MO (US)

(21) Appl. No.: 18/842,772

(22) PCT Filed: Feb. 28, 2023
(86) PCT No.: PCT/US2023/014012

§ 371 Date: Aug. 29, 2024

Related U.S. Application Data
(60) Provisional application No. 63/315,228, filed on Mar. 1, 2022.

(51) Int. Cl. H01M 10/0568; H01M 10/0525; H01M 10/0569

(52) U.S. Cl. CPC H01M 10/0568; H01M 10/0525; H01M 10/0569; H01M 2300/0042

(57) ABSTRACT

A nonaqueous electrolyte includes an organic solvent containing a carbonate solvent and 10 to 50 wt % of methyl acetate, based on a total weight of the organic solvent; and a plurality of lithium salts dissolved in the organic solvent. The lithium salts include 0.25 to 4.5 wt % of lithium difluorophosphate, 0.25 to 3 wt % of lithium bis(oxalato)borate, each based on a total weight of the nonaqueous electrolyte, and lithium hexafluorophosphate.

### CROSS-REFERENCE TO RELATED APPLICATION

The instant application claims priority to U.S. Application Ser. No. 63/315,228, filed on Mar. 1, 2022, the content of which is incorporated herein by reference in its entirety.

### BACKGROUND

This disclosure relates to a non-aqueous electrolyte, and lithium-ion batteries including the nonaqueous electrolyte. Li-ion batteries are broadly used. For some applications, high stability at elevated temperatures, while also having an ability to be charged and discharged at high rates at low temperatures, is desired. There remains a need for an improved electrolyte to provide high-rate charge and discharge at low temperatures, while also providing improved stability at elevated temperatures.

### SUMMARY

The above-described and other deficiencies of the art are met by a nonaqueous electrolyte comprising an organic solvent that comprises a carbonate solvent and 10 or greater than 10 to 50 wt % of methyl acetate, based on a total weight of the organic solvent; and a plurality of lithium salts dissolved in the organic solvent, the lithium salts comprising 0.25 to 4.5 wt % of lithium difluorophosphate, 0.25 to 3 wt % of lithium bis(oxalato)borate, each based on a total weight of the nonaqueous electrolyte, and lithium hexafluorophosphate. The nonaqueous electrolyte is prepared by providing the organic solvent, providing the plurality of lithium salts, and contacting the organic solvent with the plurality of lithium salts.

In another aspect, a lithium-ion cell comprises a positive electrode; a negative electrode; a separator interposed between the positive electrode and the negative electrode; and the above-described nonaqueous electrolyte. The lithium-ion cell is manufactured by providing the nonaqueous electrolyte, and adding the nonaqueous electrolyte to an assembly comprising the cathode; the anode; and the separator between the cathode and the anode.

Also disclosed is a method of preparing a nonaqueous electrolyte, the method including: providing an organic solvent including a carbonate solvent and 10 or greater than 10 to 50 wt % of methyl acetate, based on a total weight of the organic solvent; providing a plurality of lithium salts comprising lithium difluorophosphate, lithium bis(oxalate)borate, and lithium hexafluorophosphate; and contacting the organic solvent with the plurality of lithium salts to prepare the nonaqueous electrolyte, wherein lithium difluorophosphate is present in an amount of 0.25 to 4.5 wt % and lithium bis(oxalate)borate is present in an amount of 0.25 to 3 wt %, each based on a total weight of the nonaqueous electrolyte.

### BRIEF DESCRIPTION OF THE DRAWINGS

The following descriptions should not be considered limiting in any way.

FIGS. 1A and 1B are each a graph of voltage (volts, V) at the end of a 15 second 5 C pulse discharge versus cycle number when evaluated using a pulse discharge thermal loop for cells with an example electrolyte composition of this disclosure;

FIGS. 2A and 2B are each a graph of voltage (volts, V) at the end of a 15 second 5 C pulse discharge versus cycle number, when evaluated using a pulse discharge thermal loop for cells with comparative examples of the electrolyte composition;

FIG. 3 is a graph of voltage (volts, V) at the end of a 0.5 second 0.6 watt (W) pulse at −17° C. prior to aging (initial), after the pulse discharge thermal loop, and after the pulse discharge thermal loop and 130 hours storage at 71° C.;

FIG. 4 is a graph of voltage (volts, V) at the end of a 0.2 second 119 A pulse test at −17° C. versus the test number, where between each pulse test, the cell was aged by charge/discharge cycling for two weeks at 55° C.;

FIG. 5 is a graph of voltage (volts, V) at the end of a 5 second 29.5 A discharge at −40° C. following a charge to 4.1 V at 30° C. versus test number, where between each pulse test, the cell was aged by charge/discharge cycling for two weeks at 55° C.;

FIG. 6 is a table summarizing the C/5 capacity at 25° C., voltage at the end of a 10 second C/2 pulse at −30° C., and C/10 capacity at −30° C. before and after storage at 55° C. for 13 days for cells having electrolytes of Examples 6-10 and electrolytes of comparative examples 7-11;

FIG. 7 is a table summarizing the C/5 capacity at 25° C., voltage at the end of a 10 second C/2 pulse at −30° C., and C/10 capacity at −30° C. before and after storage at 55° C. for 13 days for cells having electrolytes of Examples 11-13;

FIG. 8 is a graph of the C/10 capacity (milliampere-hours, mAh) at −30° C. versus storage time (weeks) for electrolytes containing varying amounts of methyl acetate, where between each pulse test, the cell was aged by charge/discharge cycling for two weeks at 55° C.;

FIG. 9 is a graph of voltage (volts, V) at the end of a 10 second 1 C pulse at 95% state of charge (SOC) at −30° C. versus storage time (weeks) for cells having electrolytes containing varying amounts of methyl acetate, where between each pulse test, the cell was aged by charge/discharge cycling for two weeks at 55° C.;

FIG. 10 is a graph of the C/5 capacity (milliampere-hours, mAh) at 25° C. versus storage time (weeks) for cells having electrolytes containing varying amounts of methyl acetate, where between each pulse test, the cell was aged by charge/discharge cycling for two weeks at 55° C.;

FIG. 11 is a graph of the C/10 capacity (milliampere-hours, mAh) at −30° C. versus storage time (weeks) comparing the difference between methyl acetate and ethyl propionate and the difference between lithium bis(oxalato)borate and LiPF₂(oxalate) in electrolytes, where between each pulse test, the cell was aged by charge/discharge cycling for two weeks at 55° C.;

FIG. 12 is a graph of the voltage (volts, V) at the end of a 10 second 1 C pulse at 95% SOC at −30° C. versus storage time (weeks) comparing the difference between methyl acetate and ethyl propionate and the difference between lithium bis(oxalato)borate and LiPF₂(oxalate)₂ in electrolytes, where between each pulse test, the cell was aged by charge/discharge cycling for two weeks at 55° C.; and

FIG. 13 is a graph of the C/5 capacity (milliampere-hours, mAh) at 25° C. versus storage time (weeks) comparing the difference between methyl acetate and ethyl propionate and the difference between lithium bis(oxalato)borate and LiPF₂(oxalate) in electrolytes, where between each pulse test, the cell was aged by charge/discharge cycling for two weeks at 55° C.

### DETAILED DESCRIPTION

Many applications of Li-ion batteries require a wide range of operational temperature, for example from −40° C. to +70° C. Performance of a Li-ion cell, especially at low temperature, is often limited by the electrolyte. The ionic conductivity of the electrolyte is one transport property that helps determine how fast a cell can be charged or discharged. Among the factors that determines the conductivity of the electrolyte is its viscosity, with lower viscosity solutions having greater conductivity because of greater ion mobility.

Liquid electrolytes have a mixture of organic carbonates solvents, which have a mix of desirable and undesirable values for viscosity, dielectric constant, melting point, and ability to form a stable solid-electrolyte interface (SEI) layer. For example, dimethyl carbonate (DMC) has less viscosity than ethyl methyl carbonate (EMC), and a melting point of 5° C. versus −53° C. for EMC. Additionally, ethylene carbonate (EC) is used to form a stable SEI layer that allows good battery life, but its melting point of 34° C. and viscosity are less favorable for low temperature performance.

Efforts to improve the performance of Li-ion batteries so that they can be applied to non-consumer applications has generally focused upon increasing the conductivity of the electrolyte at low temperature, e.g., −20° C. to −40° C. Aliphatic esters such as methyl acetate (MA) may be added to organic carbonate mixtures to expand the operational temperature range to lower temperatures, in part because they have a lower viscosity and lower melting points than organic carbonates. However, the presence of MA in the electrolyte can also lower capacity retention and increase cell resistance with cell aging, with capacity retention continuing to decrease and resistance increasing with increasing MA concentration. Thus, while electrolytes with high MA concentration may improve low temperature performance, its presence in the electrolyte can cause limited cell life or reduced high temperature stability.

Certain electrolyte additives may be used to affect the performance of Li-ion batteries. While not wanting to be bound by theory, it is believed that a solid electrolyte interface (SEI) film on the surface of the negative electrode, which is ionically conductive to lithium ions and is electrically insulating, may prevent continued reduction of electrolyte and loss of capacity. If the SEI film is too thick or has a higher resistance, the cell may have poor rate performance. During cycling, if the film is not compact and suitably stable, the SEI will eventually dissolve or rupture and the exposed negative electrode will react with the electrolyte, which consumes electrolyte, and results in loss of cyclable lithium, resulting in loss of capacity. Accordingly, while electrolyte additives may be included to modify the SEI to improve cell life, e.g., to offset some of the impact of degraded life from the presence of MA, improved life can be accompanied with greater SEI film resistance, which leads to cells with higher resistance as lithium ion transfer through a more stable SEI may be more resistive, and this can negatively impact high-rate charge and discharge performance, especially at low temperatures.

The inventors hereof have discovered a nonaqueous electrolyte that provides an unexpectedly improved combination of high-rate performance at low temperature while also providing improved stability at elevated temperatures.

The nonaqueous electrolyte comprises an organic solvent and a plurality of lithium salts dissolved in the organic solvent. The lithium salts are contained in an amount of 0.25 to 4.5 wt % of lithium difluorophosphate (LDFP), 0.25 to 3 wt % of lithium bis(oxalato)borate (LiBOB), each based on a total weight of the nonaqueous electrolyte, and lithium hexafluorophosphate.

Preferably the lithium salts are contained in an amount of 0.3 to 3 wt % of LDFP and 0.3 to 2.5 wt % of LiBOB, or 0.5 to 2.5 wt % or 1.5 to 2.5 wt % of LDFP and 0.3 to 1.5 wt % or 0.3 to 0.8 wt % of LiBOB, each based on the total weight of the nonaqueous electrolyte. Lithium hexafluorophosphate can be present in an amount of 0.3 to 1.5 mole/liter (M), 0.6 to 1.2 M, or 0.7 to 1 M in the nonaqueous electrolyte.

The organic solvent comprises 10 preferably greater than 10 to 50 wt %, 15 to 50 wt %, 20 to 50 wt %, 25 to 40 wt %, or 28 to 32 wt % of methyl acetate, based on a total weight of the organic solvent. In an aspect, the organic solvent comprises 10 to 40 wt %, 15 to 35 wt %, 20 to 32 wt %, or 22 to 30 wt % of methyl acetate, based on a total weight of the organic solvent.

The organic solvent comprises a carbonate solvent. The carbonate solvent comprises ethylene carbonate (EC), and optionally dimethyl carbonate (DMC), diethyl carbonate (DEC), dipropyl carbonate, methylpropyl carbonate, ethylpropyl carbonate, methylethyl carbonate (EMC), propylene carbonate (PC), butylene carbonate, or a combination thereof. The carbonate solvent can be present in an amount of 50 to 90 wt %, 50 to 75 wt %, 50 to 80 wt %, 60 to 75 wt %, or 68 to 72 wt %, based on a total weight of the organic solvent. In an aspect, the carbonate solvent comprises 10 to 50 wt %, 15 to 50 wt %, or 17 to 35 wt % of ethylene carbonate based on a total weight of the organic solvent. The organic solvent can consist of methyl acetate and the carbonate solvent.

As a specific example, the organic solvent comprises 20 to 40 wt % of methyl acetate, 10 to 30 wt % of ethylene carbonate, 10 to 30 wt % of dimethyl carbonate, and 15 to 35 wt % of ethylmethyl carbonate, each based on a total weight of the organic solvent. As another specific example, the organic solvent comprises 20 to 25 wt % or 25 to 35 wt % of methyl acetate, 15 to 30% ethylene carbonate, 15 to 25 wt % of dimethyl carbonate, and 20 to 30 wt % of ethylmethyl carbonate, each based on a total weight of the organic solvent.

In an aspect, a combined weight of MA and DMC in the organic solvent is 45 wt % to 90 wt %, 50 wt % to 80 wt %, or 50 to 70 wt % based on a total weight of the organic solvent.

The nonaqueous electrolyte can further comprise vinylene carbonate (VC). The VC may be present in an amount of 0.25 to 3 wt %, 0.5 to 3 wt %, 0.5 to 2.5 wt %, or 1 to 2 wt % based on a total weight of the nonaqueous electrolyte.

In an aspect, the nonaqueous electrolyte comprises an organic solvent, a plurality of lithium salts dissolved in the organic solvent, and 0.5 to 3 wt % or 1 to 2 wt % of VC based on a total weight of the nonaqueous electrolyte, wherein the organic solvent comprises 20 to 40 wt % or 25 to 35 wt % of methyl acetate, 10 to 30 wt % or 15 to 30 wt % of ethylene carbonate, 10 to 30 wt % or 15 to 25 wt % of dimethyl carbonate, and 15 to 35 wt % or 20 to 30 wt % of ethylmethyl carbonate, each based on a total weight of the organic solvent; and the lithium salts comprise 1 to 3 wt % or 1.5 to 2.5 wt % of LDFP, 0.25 to 1 wt % or 0.3 to 0.8 wt % of LiBOB, each based on a total weight of the nonaqueous electrolyte, and 0.6 to 1.2 M, or 0.7 to 1 M of lithium hexafluorophosphate.

The nonaqueous electrolyte can be prepared by contacting the organic solvent with the plurality of the lithium salts and the optional vinylene carbonate. For example, the plurality of the lithium salts and the optional vinylene carbonate can be added to the organic solvent separately or in combination.

A cell having the nonaqueous electrolyte can have greater than 94% capacity retention, or greater than 95% capacity retention, after charged stand at 71° C. for five days.

In an aspect, a lithium-ion cell, e.g., a lithium-ion battery, comprises the nonaqueous electrolyte described herein. The cell includes a positive electrode; a negative electrode; a separator interposed between the positive electrode and the negative electrode; and the above-described nonaqueous electrolyte.

The positive electrode comprises a positive active material, which is not particularly limited. Preferably, the positive electrode comprises, as an active material, lithium manganese oxide (LMO), lithium nickel manganese oxide (LNMO), lithium nickel cobalt manganese oxide (NMC), lithium nickel cobalt aluminum oxide (NCA), lithium nickel cobalt oxide (LCO), lithium iron phosphate (LFP), lithium manganese iron phosphate (LMFP), or a combination of thereof. The positive electrode may comprise a metallic current collector. The current collector for the positive electrode may comprise aluminum.

The negative electrode may comprise a negative active material, such as graphite, hard carbon, silicon, or a combination thereof.

The negative electrode may comprise a metallic current collector. The current collector for the negative electrode may comprise copper.

The positive electrode and the negative electrode may each independently further comprise a binder, a conductive agent, or a combination thereof.

Representative binders include polyvinylidene difluoride, polyvinyl alcohol, carboxymethyl cellulose, starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, or a copolymer thereof. A combination comprising at least one of the foregoing may be used.

Representative conductive agents include ketjen black, carbon black, graphite, carbon nanotubes, carbon fiber, mesoporous carbon, mesocarbon microbeads, oil furnace black, extra-conductive black, acetylene black, or lamp black. A combination comprising at least one of the foregoing may be used.

The cell comprises a microporous separator disposed between the cathode and the anode. A microporous polyolefin membrane comprising polypropylene, polyethylene, or a copolymer thereof, may be used.

The cell may be manufactured by providing the nonaqueous electrolyte and adding the nonaqueous electrolyte to an assembly comprising the cathode; the anode; and the separator between the cathode and the anode.

The above described and other features are exemplified by the following examples. In the examples, unless otherwise specified, the percent (%) of the components is weight percent based on the total weight of the composition.

### EXAMPLES

The cells used in Examples 1 to 5 and Comparative Examples 1 to 6 used a lithium nickel cobalt aluminum oxide positive active material, graphite negative active material, and a microporous polypropylene separator. Each cell was filled with electrolyte, sealed under vacuum, and restrained between flat plates prior to cycling. Each cell had an initial capacity of about 14 milliampere-hours.

A base electrolyte contained lithium hexafluorophosphate, 22.5 wt % ethylene carbonate (EC), 20 wt % dimethyl carbonate (DMC), 27.5 wt % ethyl methyl carbonate (EMC), and 30 wt % methyl acetate (MA), based on a total weight of the organic carbonates (EC, DMC, and EMC) and MA. The concentration of the lithium hexafluorophosphate in the base electrolyte is 0.85 molar (M). Lithium difluorophosphate (LDFP), lithium bis(oxalato)borate (LiBOB), vinylene carbonate (VC), fluoroethylene carbonate (FEC), or lithium bis(trifluoromethanesulfonimide) (LFSI) were added to the base electrolyte to make the electrolytes used in Examples 1 to 5 and Comparative Examples 1 to 6. The compositions of the electrolytes Examples 1 to 5 (Ex 1 to Ex 5) and Comparative Examples 1 to 6 (CEx 1 to CEx 6) are summarized in Tables 1 and 2. The contents of the LDFP, LiBOB, or VC added for these examples and comparative examples were based on the weight of the base electrolyte, i.e., 0.85 molar (M) lithium hexafluorophosphate, 22.5 wt % EC, 20 wt % DMC, 27.5 wt % EMC, and 30 wt % MA where a 100 g base electrolyte solution containing organic solvents, and LiPF₆ with 1 wt % LDFP and 1 wt % LiBOB would have 1 g each of LDFP and LiBOB for a total solution weight of 102 g. In other words, the percent of the additives in Table 1 and Table 2 can be considered as part(s) by weight per 100 parts by weight of the base electrolyte.

TABLE 1

| Example | Additive(s) added to the base electrolyte |
|---|---|
| Ex 1 | 1% LDFP + 0.8% LiBOB |
| Ex 2 | 1% LDFP + 0.8% LiBOB + 0.5% VC |
| Ex 3 | 1% LDFP + 0.5% LiBOB + 1.5% VC |
| Ex 4 | 2% LDFP + 0.5% LiBOB + 1.5% VC |
| Ex 5 | 1% LDFP + 1% LiBOB |

TABLE 2

| Comparative Example | Additive(s) added to the base electrolyte |
|---|---|
| CEx 1 | 1% LDFP |
| CEx 2 | 1% LDFP + 1% FEC |
| CEx 3 | 1% LDFP + 0.5% VC |
| CEx 4 | 1% LDFP + 1% LFSI |
| CEx 5 | 0.5% VC+ 0.8% LiBOB |
| CEx 6 | 1.5% VC + 0.5% LiBOB |

The cells were initially charged and cycled at a 7 milliampere (mA) rate between 4.1 V and 3 V. After charging to 4.1 V at 30° C., cells were cooled to −17° C., allowed to thermally equilibrate, and then discharged using a 0.5 second, 0.6 W pulse. Each cell was then pulse discharged in a pulse discharge thermal loop at different temperatures according to Table 3. Each pulse discharge cycle consisted of one 15 second 0.4 C pulse, five 4 second 4 C pulses, a 0.0165 ampere hour (Ah) discharge at 1 C, one 15 second 5 C discharge and recharge at C/2 to 4.1 V. Following the pulse discharge thermal loop, the cells were thermally equilibrated at 30° C. and charged to 4.1 V, cooled −17° C., allowed to thermally equilibrate, and a 0.5 second, 0.6 W pulse discharge was performed. The cells were then charged to 4.1 V, and stored at open-circuit for 5 days at 71° C. After storage at 71° C., the cells were again charged to 4.1 V at 30° C., cooled to −17° C., allowed to thermally equilibrate, and discharged using a 0.5 second, 0.6 W pulse.

TABLE 3
Pulse Discharge Thermal Loop

| Temp. (° C.) | Number of pulse sequences |
|---|---|
| 30 | 36 |
| 0 | 54 |
| −26 | 2 |
| 55 | 36 |

### Effect of Electrolyte Additives

For Examples 1 and 2 (Ex 1 and Ex 2), and Comparative Examples 1 to 6 (CEx 1 to CEx 6), the initial capacity, capacity and capacity retention following the pulse discharge thermal loop before and after charged storage at 71° C. are summarized in Table 4. Capacity was determined by discharge at C/2.

TABLE 4

| | Initial | Capacity after | Retention after | Capacity after thermal | Retention after thermal |
|---|---|---|---|---|---|
| Ex or | Capacity | thermal loop | thermal loop | loop and charged stand | loop and charged stand at |
| CEx | (mAh) | (mAh) | (%) | at 71° C. (mAh) | 71° C. (%) |
| Ex 1 | 15.1 | 14.7 | 97.7 | 14.5 | 96.0 |
| Ex 2 | 14.9 | 14.6 | 98.0 | 14.5 | 97.2 |
| CEx 1 | 14.5 | 14.2 | 97.8 | 13.5 | 93.4 |
| CEx 2 | 14.5 | 14.0 | 96.6 | 13.5 | 93.2 |
| CEx 3 | 14.8 | 14.2 | 96.1 | 13.8 | 93.0 |
| CEx 6 | 15.2 | 14.9 | 98.2 | 14.3 | 94.3 |
| CEx 5 | 15.6 | 15.4 | 98.9 | 14.6 | 93.7 |
| CEx 4 | 15.2 | 14.8 | 97.3 | 14.2 | 92.7 |

The results in Table 4 show that cells with LDFP (CEx 1) have 93.4% capacity retention, and cells having a combination of LDFP and LiBOB have an improved capacity retention of 96% (Ex 1). Cells with a combination of LDFP, LiBOB, and VC (Ex 2) have further improved capacity retention of 97.2%, while the comparative example cells with LDFP and VC but without LiBOB (CEx 3), cells with LiBOB and VC but without LDFP (CEx 5 and CEx 6), and cells with LDFP as the only additive (CEx 1) have capacity retention of about 93%, 93.7%, 94.3%, and 93.4% respectively. These results show that the combination of MA with LDFP and LiBOB provides unexpectedly improved high temperature stability (capacity retention after thermal loop cycling and charged stand at 71° C.), and that high temperature stability can be further improved by addition of VC.

The results in Table 4 also indicate that FEC (CEx 2) and LFSI (CEx 4), when combined with LDFP, worsen rather than improve capacity retention, relative to when only LDFP is used. The adverse effect of FEC and LFSI illustrates the unpredictability of the synergistic effect observed when using MA with LDFP and LiBOB.

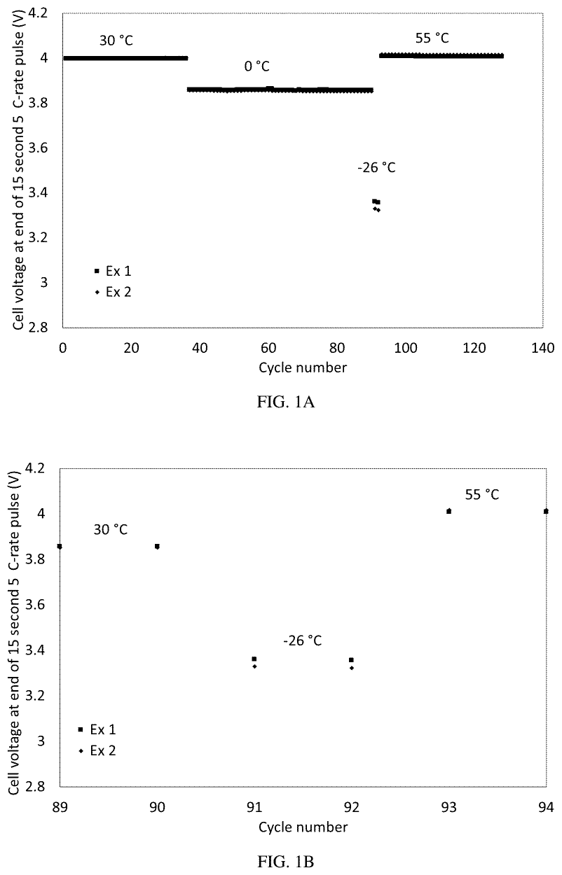

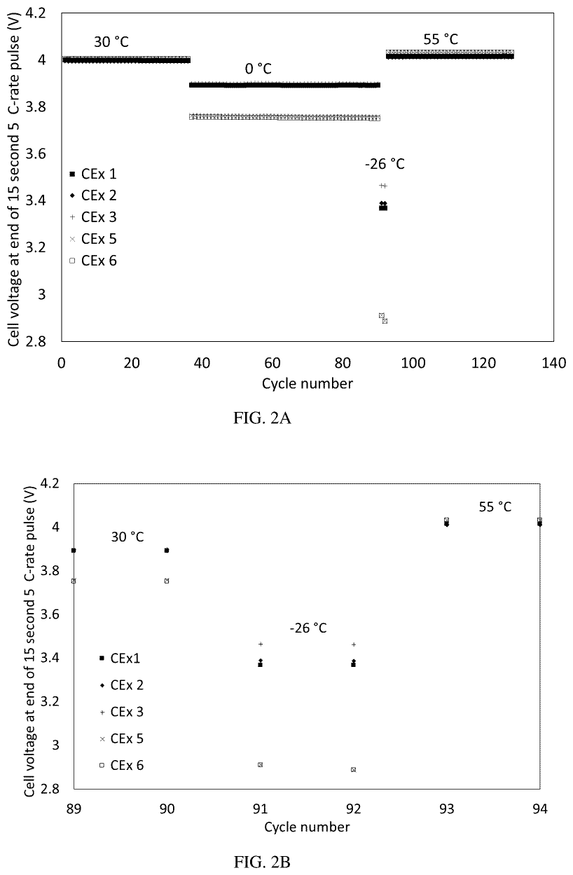

FIGS. 1A and 1B and FIGS. 2A and 2B show the cell voltage at the end of a 15 second 5 C pulse discharge at 30° C., 0° C., −26° C., and 55° C. versus cycle number. Electrolytes with the example composition (FIGS. 1A and 1B) and those of the Comparative Examples (FIGS. 2A and 2B) are separated in the graphs for clarity. The results have overlapping symbols as shown in these figures. As shown in FIGS. 1A and 1B and FIGS. 2A and 2B, the cells with LDFP have greater voltage at low temperature compared to cells without LDFP. As shown in Table 4, the cells having the disclosed electrolyte also have improved capacity retention following charged stand at 71° C.

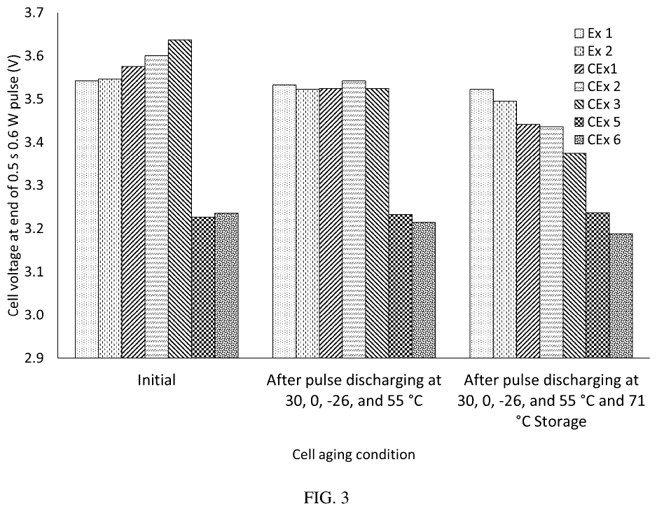

FIG. 3 shows the voltage at the end of the 0.5 second 0.6 W pulse discharge at −17° C. initially, following the pulse discharge thermal loop, and following the pulse discharge thermal loop with additional storage at 71° C. for 130 hours. These results illustrate that when MA, LDFP, and LiBOB are used in combination as in Ex 1 and Ex 2, the end-of-pulse cell voltage is improved relative to cells using electrolytes that do not have this combination, e.g., have only VC and LiBOB (CEx 5 and CEx 6). Thus the combination of LDFP with LiBOB (Ex 1), and the combination of LDFP, LiBOB, and VC (Ex 2), provide both good capacity retention (Table 4) and improved cell voltage when pulse discharged (FIG. 3). These results demonstrate that high power may be provided at low temperature, while also providing improved high-temperature capacity retention through use of MA with LDFP, LiBOB, and optionally VC.

The synergistic effects of MA, LDFP, and LiBOB are further illustrated in 5.5 Ah prismatic cells in Ex 3 to Ex 5 in comparison to CEx 6. The materials are otherwise the same as in Example 1.

For Ex 3 to Ex 5 and CEx 6, after charging to 4.1 V at 30° C., cell voltage at the end of a 0.5 second, 119 A pulse discharge at −17° C., and at the end of a 15 second 29.5 A discharge at −40° C. were determined. The cells were then cycled at 55° C. for two weeks. Each cycle at 55° C. consisted of:
1. 2.75 A charge to 4.1 V, hold at 4.1V to 0.11 A,
2. 10 min open circuit,
3. 1 Ah discharge at 11 A, and
4. 10 min open circuit.

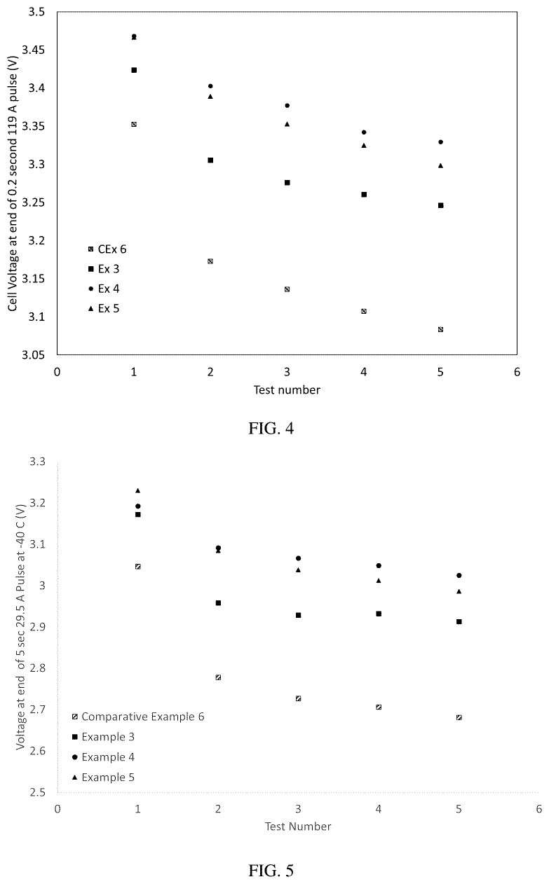

Every two weeks (approximately 400 cycles), the cell voltage at the end of a 0.5 second, 119 A pulse discharge at −17° C. (FIG. 4), and at the end of a 15 second 29.5 A discharge at −40° C. (FIG. 5) were determined. The results in FIGS. 4 and 5 show that at both −17° C. and −40° C., the cells with example electrolytes (Ex 3 to Ex 5) provide higher voltages at the end of the respective pulse discharges compared to CEx 6.

### Examples 6-17 and Comparative Examples 7-12

Examples 6 to 17 and Comparative Examples 7 to 12 further show the effect of LDFP, LiBOB, and MA to improve the high temperature stability and low temperature pulse discharge voltage when using a range of organic carbonates. The cells used in these examples are multilayer pouch cells (Pred Materials International) having a capacity of about 170 mAh. The cells included a NCA cathode, an artificial graphite anode, and a microporous polyethylene separator having a 4 μm ceramic coating on the cathode side. Dry cells were filled with 1 milliliter (mL) of the electrolyte and sealed under vacuum. The cells were then cycled between 4.2 V and 3 V, degassed, and resealed under vacuum.

Testing of these cells was performed at two-week intervals at 25° C. and at −30° C. For both temperatures, the cells were charged at 34 mA (C/5) to 4.2 V with a constant voltage hold until current decreased to 8.5 mA prior to discharge. Testing at 25° C. was a C/5 rate discharge to 3.0 V. At −30° C., testing consisted of a 17 mA (C/10) discharge with a 10 second 170 mA (1 C) discharge at 95% state-of-charge with continued discharge to 3.0 V after the 10 second pulse. The total capacity upon discharge from 4.2 to 3.0 V was recorded as was the voltage at the end of the 10 second 170 mA pulse. Cells were then charged at C/5 to 4.2 V with a constant voltage hold until the current decreased to C/20. The cells were then stored at 55° C. at OCV for 13 days or for two weeks when testing was repeated.

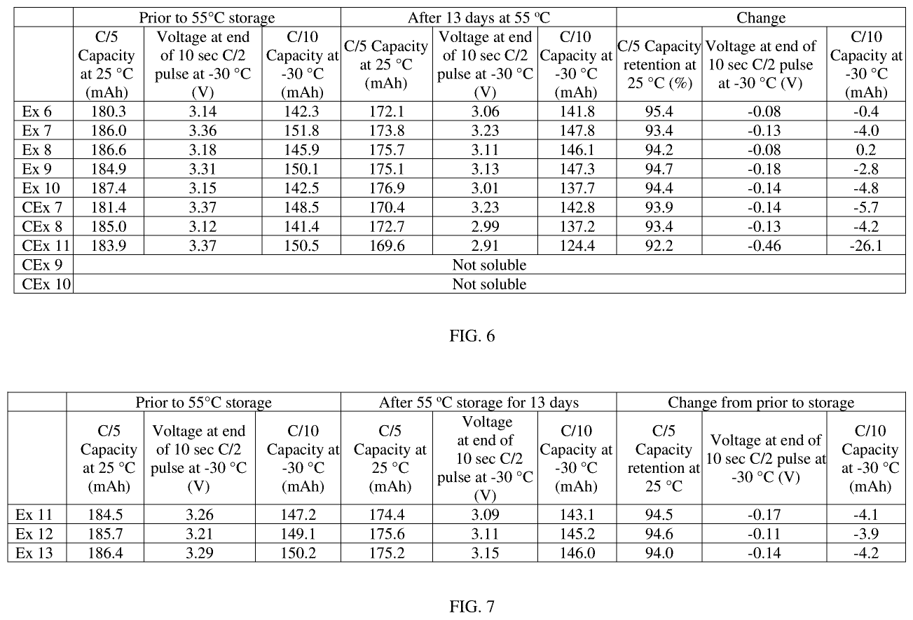

For Ex 6 to Ex 10 and CEx 7 to 11, a base electrolyte contained 0.85 M lithium hexafluorophosphate, 22.5 wt % ethylene carbonate (EC), 20 wt % dimethyl carbonate (DMC), 27.5 wt % ethyl methyl carbonate (EMC), and 30 wt % methyl acetate (MA), based on a total weight of the organic carbonates (EC, DMC, and EMC) and methyl acetate. LDFP, LiBOB, and VC were added to the base electrolyte to make the electrolytes as shown in Table 5. The results are summarized in FIG. 6.

TABLE 5

| | LDFP | LiBOB | VC | Base Electrolyte |
|---|---|---|---|---|
| | (parts by | (parts by | (parts by | (parts by |
| Ex/CEx | weight) | weight) | weight) | weight) |
| Ex 6 | 2 | 3 | 0 | 100 |
| Ex 7 | 2 | 0.25 | 0 | 100 |
| Ex 8 | 0.25 | 0.75 | 0 | 100 |
| Ex 9 | 2 | 0.5 | 0.5 | 100 |
| Ex 10 | 2 | 0.5 | 3 | 100 |
| CEx 7 (no LiBOB) | 2 | 0 | 0 | 100 |
| CEx 8 (no LDFP) | 0 | 0.75 | 0 | 100 |
| CEx 9 (high LDFP) | 7 | 0.75 | 0 | 100 |
| CEx 10 (high LiBOB) | 2 | 5 | 0 | 100 |
| CEx 11 (high LDFP) | 5 | 0.75 | 0 | 100 |

The comparative examples that comprised only LDFP (CEx 7) or only LiBOB (CEx 8) as additives were inferior to the Ex 6 to Ex 10, which comprised both LDFP and LiBOB. CEx 7, which included 2% LDFP and no LiBOB, had 25° C. capacity retention after storage at 55° C. of 170.4 mAh, which was less than the corresponding value for Ex 6 to Ex 10, which ranged from 172.1 Ah to 176.9 Ah. At −30° C., the C/10 capacity of CEx 7 decreased by 5.7 mAh relative to the initial capacity, whereas Ex 6 to Ex 10 either increased 0.2 mAh or decreased up to 4.8 mAh relative to their initial capacity, illustrating the stabilizing effect of LDFP and LiBOB when used in combination. CEx 8, which included LiBOB and did not include LDFP, had an end of pulse voltage of 2.99V after 55° C. storage, which was less than the comparable value for Ex 6 to Ex 10, which varied from 3.01V to 3.23V. Also, the capacity at −30° C. of CEx 8 after 55° C. storage was 137.2 mAh, which is less than the corresponding value of Ex 6 to Ex 10, which varied from 137.7 mAh to 147.8 mAh. Electrolytes with LDFP and LiBOB concentrations of 7 wt % and 5 wt % respectively (CEx 9 and CEx 10) were not fully soluble. CEx 11 provided a capacity of 124.4 mAh at −30° C. and an end of pulse voltage of 2.91 V after 55° C. storage, both of which are less than the comparable values for Ex 6 to Ex 10, illustrating the effect of LDFP concentrations greater than 4.5%, e.g., 5%.

Examples 11 to 13 each included the same content of LDFP, LiBOB, vinylene carbonate (VC), and 30 wt % MA, and each included a different carbonate combination as provided in Table 6. The concentration of the lithium hexafluorophosphate in the base electrolyte is 0.85 molar (M).

TABLE 6

| | | | | Base | MA | |
|---|---|---|---|---|---|---|
| Examples/ | LDFP | LiBOB | VC | Electrolyte | (wt % based | |
| Comparative | (parts by | (parts by | (parts by | (parts by | on MA + | Carbonates |
| Examples | weight) | weight) | weight) | weight) | carbonates) | (weight ratio) |
| Ex 11 | 2 | 0.5 | 1.5 | 100 | 30 | 22.5:20:27.5 |
| | | | | | | EC:DMC:DEC |
| Ex 12 | 2 | 0.5 | 1.5 | 100 | 30 | 1:1:1:1 |
| | | | | | | EC:DMC:EMC:DEC |
| Ex 13 | 2 | 0.5 | 1.5 | 100 | 30 | 3:7 EC:DMC |

Results before and after 55° C. storage are provided in FIG. 7. The results show that the unexpected improvement in capacity and pulse discharge capability after 55° C. storage is provided for the range carbonate compositions provided in Ex 11 to Ex 13. Ex 11 and Ex 12 demonstrate that DEC may also be used as organic carbonate. Ex 12 and Ex 13 further demonstrate that a quaternary and binary organic carbonate mixtures, respectively, are suitable organic carbonate mixtures.

Examples 4 and 14 to 16 and Comparative Examples 11 and 12 each included the same ratio of organic carbonates (EC:DMC:EMC weight ratio of 22.5:20:27.5) and the LDFP, LiBOB, and VC were kept constant at 2, 0.5, and 1.5% respectively, as a percentage of the organic carbonates, methyl acetate, and LiPF₆ salt. The concentration of methyl acetate was different between each of these Examples and Comparative Examples with the methyl acetate percentage shown in Table 7 being a percentage based on the combination of the weight of methyl acetate and organic carbonates. The concentration of the lithium hexafluorophosphate in the base electrolyte is 0.85 molar (M).

TABLE 7

| | wt % Organic Carbonate | wt % Methyl Acetate |
|---|---|---|
| Ex 4 | 70 | 30 |
| Ex 14 | 90 | 10 |
| Ex 15 | 80 | 20 |
| Ex 16 | 60 | 40 |
| Ex17 | 50 | 50 |
| CEx 11 | 100 | 0 |
| CEx 12 | 40 | 60 |

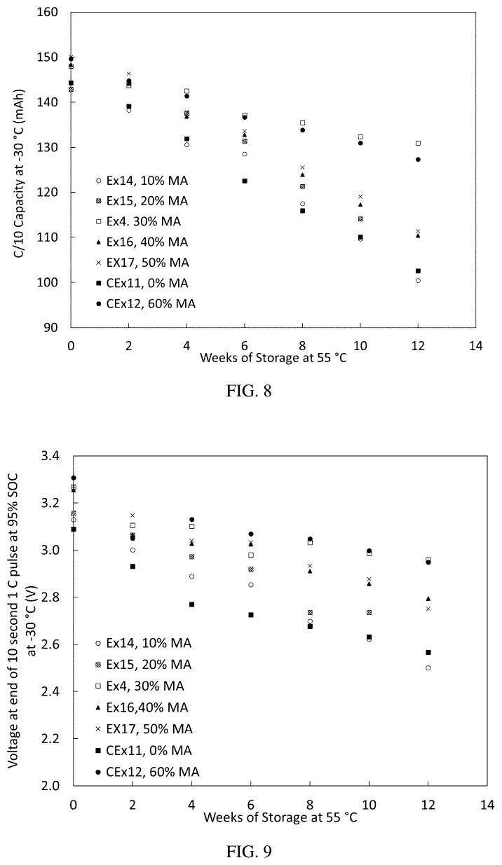

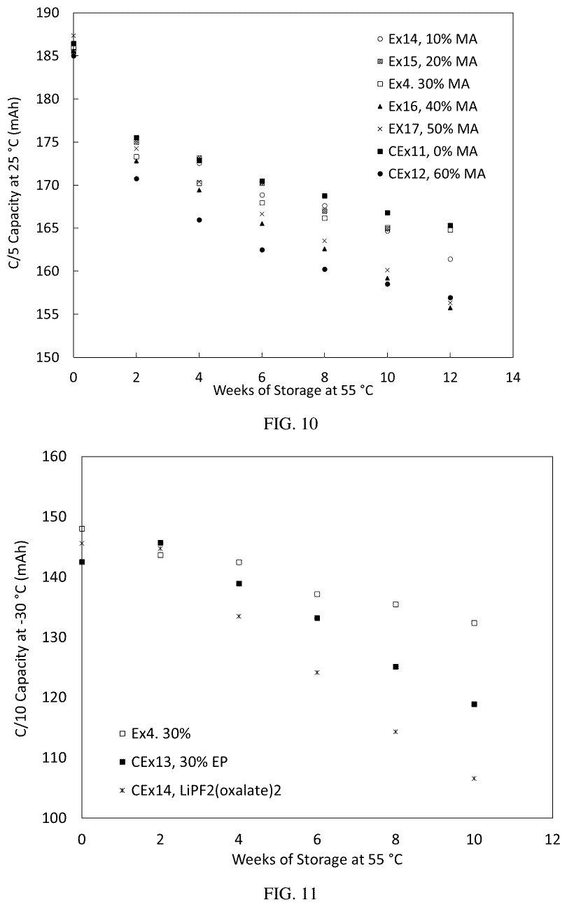

The results are shown in FIGS. 8 to 10. Cells with greater than 10 wt % MA (Ex 4, Ex 14 to Ex 17 and CEx 12) have greater discharge capacity and a higher voltage at the end of the 10 second 1 C pulse at −30° C. than those with MA concentrations of 10 wt % or less, e.g., Ex 14 and CEx 11, as shown in FIG. 8 and FIG. 9. Cells had increasingly better performance (higher voltage during pulse and capacity) at −30° C. with increasing MA amounts to less than 40%, but also had greater capacity fade at 25° C. (Ex 4, Ex 14-15, CEx 11). When 40 wt %, 50 wt %, or 60 wt % of MA was included (Ex 16, Ex 17, and CEx 12), the −30° C. performance was similar, but the 25° C. capacity retention continued to fade with increasing MA. Capacity retention at room temperature, FIG. 10, was greatest for cells with electrolytes having MA concentrations of less than 40% (Ex 4, Ex 14, Ex 15, and CEx 11). These results indicate that MA reduces cell life and improves low temperature performance. These results also show that there is a balance between MA concentration with this additive combination between low temperature performance and long-term life. These results show that increasing MA concentration up to less than 40% can improve low temperature performance with minimal loss to capacity retention, and that MA concentration at 40%, 50%, and 60% can be detrimental to ambient temperature capacity retention after storage at elevated temperature, without adding significant performance at low temperature.

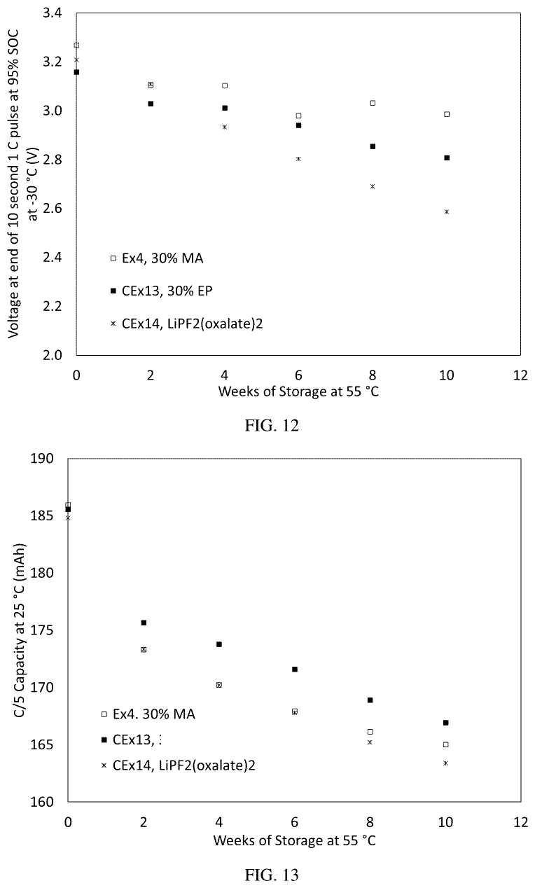

Example 4 and Comparative Example 13 had the same composition except that Comparative Example 13 had 30 wt % ethyl propionate (EP) in place of the 30 wt % MA in Example 4. Comparative Example 14 had 0.5 wt % LiPF₂(oxalate)₂ as an additive in place of LiBOB in Example 4. The results are shown if FIGS. 11 to 13. FIGS. 11 and 12 show the superior retention of capacity and voltage response during a 1 C pulse at −30° C. with aging at 55° C. of electrolytes with MA and LiBOB. The electrolyte with EP (CEx 13) has worse −30° C. capacity retention and voltage response when the cell is aged at 55° C., compared to cells with MA, while its room temperature capacity is superior. The electrolyte with LiPF₂(oxalate)₂ (CEx 14) has worse −30° C. capacity retention and voltage response when the cell is aged at 55° C., compared to cells with LiBOB while its room temperature capacity is about the same with aging.

Set forth below are various aspects of the disclosure.
Aspect 1. A nonaqueous electrolyte comprising: an organic solvent comprising a carbonate solvent and 10 or greater than 10 to 50 wt % of methyl acetate, based on a total weight of the organic solvent; and a plurality of lithium salts dissolved in the organic solvent, the lithium salts comprising 0.25 to 4.5 wt % of lithium difluorophosphate, 0.25 to 3 wt % of lithium bis(oxalate)borate, each based on a total weight of the nonaqueous electrolyte, and lithium hexafluorophosphate.
Aspect 2. The nonaqueous electrolyte as in any prior aspect, wherein the lithium salts comprise: 0.3 to 3 wt % of lithium difluorophosphate, 0.3 to 2.5 wt % of lithium bis(oxalate)borate, each based on the total weight of the nonaqueous electrolyte, and lithium hexafluorophosphate, optionally present in an amount of 0.3 to 1.5 M, 0.6 to 1.2 M, or 0.7 to 1 M in the nonaqueous electrolyte.
Aspect 3. The nonaqueous electrolyte as in any prior aspect, wherein the lithium salts consist of lithium difluorophosphate, lithium bis(oxalate)borate, and lithium hexafluorophosphate.
Aspect 4. The nonaqueous electrolyte as in any prior aspect, wherein the organic solvent comprises 20 to 40 wt % of the methyl acetate, based on the total weight of the organic solvent.
Aspect 5. The nonaqueous electrolyte as in any prior aspect, wherein the carbonate solvent is present in an amount of 60 to 80 wt % based on the total weight of the organic solvent.
Aspect 6. The nonaqueous electrolyte as in any prior aspect, wherein the carbonate solvent comprises ethylene carbonate and optionally dimethyl carbonate, diethyl carbonate, dipropyl carbonate, methylpropyl carbonate, ethylpropyl carbonate, methylethyl carbonate, propylene carbonate, butylene carbonate, or a combination thereof, and wherein the ethylene carbonate is present in an amount of 10 to 50 wt % based on a total weight of the organic solvent.
Aspect 7. The nonaqueous electrolyte as in any prior aspect, wherein the organic solvent comprises 20 to 40 wt % of the methyl acetate, 10 to 30 wt % of ethylene carbonate, 10 to 30 wt % of dimethyl carbonate, and 15 to 35 wt % of ethylmethyl carbonate, each based on the total weight of the organic solvent.
Aspect 8. The nonaqueous electrolyte as in any prior aspect, further comprising vinylene carbonate.
Aspect 9. The nonaqueous electrolyte as in any prior aspect, wherein the vinylene carbonate is present in an amount of 0.5 to 3 wt %, based on the total weight of the nonaqueous electrolyte.
Aspect 10. The nonaqueous electrolyte as in any prior aspect, wherein a cell having the nonaqueous electrolyte has greater than 94% capacity retention after charged stand at 100% state-of-charge at 71° C. for five days.
Aspect 11. A lithium-ion cell comprising: a positive electrode; a negative electrode; a separator interposed between the positive electrode and the negative electrode; and a nonaqueous electrolyte comprising an organic solvent, which comprises a carbonate solvent and 10 or greater than 10 to 50 wt % of methyl acetate, based on a total weight of the organic solvent; and a plurality of lithium salts dissolved in the organic solvent, the lithium salts comprising: 0.25 to 4.5 wt % of lithium difluorophosphate, 0.25 to 3 wt % of lithium bis(oxalato)borate, each based on a total weight of the nonaqueous electrolyte, and lithium hexafluorophosphate.
Aspect 12. The lithium-ion cell as in any prior aspect, wherein the lithium salts comprise: 0.25 to 4.5 wt % of lithium difluorophosphate, 0.25 to 3 wt % of lithium bis(oxalato)borate, each based on the total weight of the nonaqueous electrolyte, and lithium hexafluorophosphate, optionally present in an amount of 0.3 to 1.5 M, 0.6 to 1.2 M, or 0.7 to 1 M in the nonaqueous electrolyte.
Aspect 13. The lithium-ion cell as in any prior aspect, wherein the lithium salts consist of lithium difluorophosphate, lithium bis(oxalate)borate, and lithium hexafluorophosphate.
Aspect 14. The lithium-ion cell as in any prior aspect, wherein the organic solvent comprises 20 to 40 wt % of the methyl acetate, based on the total weight of the organic solvent.
Aspect 15. The lithium-ion cell as in any prior aspect, wherein the carbonate solvent comprises ethylene carbonate and optionally dimethyl carbonate, diethyl carbonate, dipropyl carbonate, methylpropyl carbonate, ethylpropyl carbonate, methylethyl carbonate, propylene carbonate, butylene carbonate, or a combination thereof, and wherein ethylene carbonate is present in an amount of 10 to 50 wt % based on a total weight of the organic solvent.
Aspect 16. The lithium-ion cell as in any prior aspect, wherein the carbonate solvent is present in an amount of 60 to 80 wt % based on the total weight of the organic solvent.
Aspect 17. The lithium-ion cell as in any prior aspect, wherein the organic solvent comprises 20 to 40 wt % of the methyl acetate, 10 to 30 wt % of ethylene carbonate, 10 to 30 wt % of dimethyl carbonate, and 15 to 35 wt % of ethylmethyl carbonate, each based on the total weight of the organic solvent.
Aspect 18. The lithium-ion cell as in any prior aspect, wherein the nonaqueous electrolyte further comprises vinylene carbonate.
Aspect 19. The lithium-ion cell as in any prior aspect, wherein the vinylene carbonate is present in an amount of 0.5 to 3 wt % based on the total weight of the nonaqueous electrolyte.
Aspect 20. The lithium-ion cell as in any prior aspect, wherein the lithium-ion cell has greater than 94% capacity retention after charged stand at 71° C. for five days.
Aspect 21. A method of preparing a nonaqueous electrolyte, the method comprising: providing an organic solvent comprising a carbonate solvent and 10 or greater than 10 to 50 wt % of methyl acetate, based on a total weight of the organic solvent; providing a plurality of lithium salts comprising lithium difluorophosphate, lithium bis(oxalate)borate, and lithium hexafluorophosphate; and contacting the organic solvent with the plurality of lithium salts to prepare the nonaqueous electrolyte, wherein the lithium difluorophosphate is present in an amount of 0.25 to 4.5 wt % and the lithium bis(oxalato)borate is present in an amount of 0.25 to 3 wt %, each based on a total weight of the nonaqueous electrolyte.
Aspect 22. A method of manufacturing a lithium-ion cell, the method comprising: providing the nonaqueous electrolyte as in any prior aspect; and adding the nonaqueous electrolyte to an assembly comprising a cathode, an anode, and a separator between the cathode and the anode to manufacture the lithium-ion cell.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt. % to 25 wt %,” etc.). “Combinations” is inclusive of blends, mixtures, alloys, reaction products, and the like. The terms “a” and “an” and “the” do not denote a limitation of quantity and are to be construed to cover both the singular and the plural, unless otherwise indicated herein or clearly contradicted by context. “Or” means “and/or” unless clearly stated otherwise. A “combination thereof” is open and includes any combination comprising at least one of the listed components or properties optionally together with a like or equivalent component or property not listed.

All cited patents, patent applications, and other references are incorporated herein by reference in their entirety. If a term in the present application contradicts or conflicts with a term in an incorporated reference, the term from the present application takes precedence over the conflicting term from the incorporated reference.

While embodiments have been set forth for the purpose of illustration, the foregoing descriptions should not be deemed a limitation on the scope herein. Accordingly, various modifications, adaptations, and alternatives can occur to one skilled in the art without departing from the spirit and scope herein.

We claim:

1. A nonaqueous electrolyte comprising:
an organic solvent comprising a carbonate solvent and 10 to 50 wt % of methyl acetate, based on a total weight of the organic solvent; and
a plurality of lithium salts dissolved in the organic solvent, the lithium salts comprising
0.25 to 4.5 wt % of lithium difluorophosphate,
0.25 to 3 wt % of lithium bis(oxalato)borate, each based on a total weight of the nonaqueous electrolyte, and
lithium hexafluorophosphate.

2. The nonaqueous electrolyte of claim 1, wherein the lithium salts comprise:
0.3 to 3 wt % of lithium difluorophosphate,
0.3 to 2.5 wt % of lithium bis(oxalato)borate, each based on the total weight of the nonaqueous electrolyte, and
lithium hexafluorophosphate.

3. The nonaqueous electrolyte of claim 1, wherein the lithium salts consist of lithium difluorophosphate, lithium bis(oxalato)borate, and lithium hexafluorophosphate.

4. The nonaqueous electrolyte of claim 1, wherein the organic solvent comprises 20 to 40 wt % of the methyl acetate, based on the total weight of the organic solvent.

5. The nonaqueous electrolyte of claim 4, wherein the carbonate solvent is present in an amount of 60 to 80 wt % based on the total weight of the organic solvent.

6. The nonaqueous electrolyte of claim 1, wherein the carbonate solvent comprises ethylene carbonate and optionally dimethyl carbonate, diethyl carbonate, dipropyl carbonate, methylpropyl carbonate, ethylpropyl carbonate, methylethyl carbonate, propylene carbonate, butylene carbonate, or a combination thereof, and wherein the ethylene carbonate is present in an amount of 10 to 50 wt % based on a total weight of the organic solvent.

7. The nonaqueous electrolyte of claim 1, wherein the organic solvent comprises
20 to 40 wt % of the methyl acetate,
10 to 30 wt % of ethylene carbonate,
10 to 30 wt % of dimethyl carbonate, and
15 to 35 wt % of ethylmethyl carbonate,
each based on the total weight of the organic solvent.

8. The nonaqueous electrolyte of claim 1, further comprising vinylene carbonate.

9. The nonaqueous electrolyte of claim 8, wherein the vinylene carbonate is present in an amount of 0.5 to 3 wt %, based on the total weight of the nonaqueous electrolyte.

10. The nonaqueous electrolyte of claim 1, wherein a cell having the nonaqueous electrolyte has greater than 94% capacity retention after charged stand at 100% state-of-charge at 71° C. for five days.

11. A lithium-ion cell comprising:
a positive electrode;
a negative electrode;
a separator interposed between the positive electrode and the negative electrode; and
a nonaqueous electrolyte comprising
an organic solvent, which comprises a carbonate solvent and 10 to 50 wt % of methyl acetate, based on a total weight of the organic solvent; and
a plurality of lithium salts dissolved in the organic solvent, the lithium salts comprising:
0.25 to 4.5 wt % of lithium difluorophosphate,
0.25 to 3 wt % of lithium bis(oxalato)borate, each based on a total weight of the nonaqueous electrolyte, and
lithium hexafluorophosphate.

12. The lithium-ion cell of claim 11, wherein the lithium salts comprise:
0.25 to 4.5 wt % of lithium difluorophosphate,
0.25 to 3 wt % of lithium bis(oxalato)borate, each based on the total weight of the nonaqueous electrolyte, and
lithium hexafluorophosphate.

13. The lithium-ion cell of claim 11, wherein the lithium salts consist of lithium difluorophosphate, lithium bis(oxalato)borate, and lithium hexafluorophosphate.

14. The lithium-ion cell of claim 11, wherein the organic solvent comprises 20 to 40 wt % of the methyl acetate, based on the total weight of the organic solvent.

15. The lithium-ion cell of claim 11, wherein the carbonate solvent comprises ethylene carbonate and optionally dimethyl carbonate, diethyl carbonate, dipropyl carbonate, methylpropyl carbonate, ethylpropyl carbonate, methylethyl carbonate, propylene carbonate, butylene carbonate, or a combination thereof, and wherein ethylene carbonate is present in an amount of 10 to 50 wt % based on a total weight of the organic solvent.

16. The lithium-ion cell of claim 15, wherein the carbonate solvent is present in an amount of 60 to 80 wt % based on the total weight of the organic solvent.

17. The lithium-ion cell of claim 11, wherein the organic solvent comprises
20 to 40 wt % of the methyl acetate,
10 to 30 wt % of ethylene carbonate,
10 to 30 wt % of dimethyl carbonate, and
15 to 35 wt % of ethylmethyl carbonate,
each based on the total weight of the organic solvent.

18. The lithium-ion cell of claim 11, wherein the nonaqueous electrolyte further comprises vinylene carbonate.

19. The lithium-ion cell of claim 18, wherein the vinylene carbonate is present in an amount of 0.5 to 3 wt % based on the total weight of the nonaqueous electrolyte.

20. The lithium-ion cell of claim 11, wherein the lithium-ion cell has greater than 94% capacity retention after charged stand at 71° C. for five days.

21. A method of preparing a nonaqueous electrolyte, the method comprising:
providing an organic solvent comprising a carbonate solvent and 10 to 50 wt % of methyl acetate, based on a total weight of the organic solvent;
providing a plurality of lithium salts comprising lithium difluorophosphate, lithium bis(oxalato)borate, and lithium hexafluorophosphate; and
contacting the organic solvent with the plurality of lithium salts to prepare the nonaqueous electrolyte,
wherein the lithium difluorophosphate is present in an amount of 0.25 to 4.5 wt % and the lithium bis(oxalate)borate is present in an amount of 0.25 to 3 wt %, each based on a total weight of the nonaqueous electrolyte.

22. A method of manufacturing a lithium-ion cell, the method comprising:
providing the nonaqueous electrolyte of claim 1; and
adding the nonaqueous electrolyte to an assembly comprising a cathode, an anode, and a separator between the cathode and the anode to manufacture the lithium-ion cell.
